(19) United States
(12) Patent Application Publication
(10) Pub. No.: US 2009/0100256 A1
(43) Pub. Date: Apr. 16, 2009

(54) Device and Method for Device Configuration

(76) Inventor: James R. Fuccello, Patchogue, NY (US)

Correspondence Address: Fay Kaplun & Marcin, LLP/ Motorola, 150 Broadway Suite 702, New York, NY, 10038, US

(21) Appl. No.: 11/869,903

(22) Filed: Oct. 10, 2007

(51) Int. Cl. G06F 9/00

(52) U.S. Cl. 713/100

(57) ABSTRACT

A device and method is used to configure devices. The device includes a memory storing scheduling data and configuration data. The device also includes at least one selectively configurable device component, wherein the device configures the at least one component as a function of the scheduling data and the configuration data. The method includes the steps of receiving scheduling data and storing the scheduling data along with configuration data on a memory of a device. The method also includes the step of selectively configuring a component of the device, wherein the configuration is a function of the scheduling data and the configuration data.

### FIELD OF INVENTION

The present application generally relates to devices and methods for device configuration.

### BACKGROUND INFORMATION

Users of electronic devices often fail to perform a desired device configuration. For example, while rushing from one meeting to another, a user may bring an electronic device, but forget to configure it for silent operation and/or forget to download files that are needed for the other meeting. This may result in the user being unprepared and/or unintentionally disruptive during the other meeting.

### SUMMARY OF THE INVENTION

The present invention relates to a device including a memory storing scheduling data and configuration data. The device also includes at least one selectively configurable device component, wherein the device configures the at least one component as a function of the scheduling data and the configuration data.

The present invention further relates to a method including the steps of receiving scheduling data and storing the scheduling data along with configuration data on a memory of a device. The method also includes the step of selectively configuring a component of the device, wherein the configuration is a function of the scheduling data and the configuration data.

The present invention further relates to a device including a storage means storing scheduling data and configuration data. The device also includes at least one selectively configurable component means for performing an action, wherein the device configures the at least one component means as a function of the scheduling data and the configuration data.

### BRIEF DESCRIPTION OF THE DRAWINGS

FIG. 1 shows a system according to an exemplary embodiment of the present invention.

FIG. 2 shows a block diagram of a device according to the present invention.

FIG. 3 shows an exemplary method according to the present invention.

FIG. 4 shows an exemplary embodiment of scheduling data according to the present invention.

### DETAILED DESCRIPTION

The present invention may be further understood with reference to the following description and the appended drawings, wherein like elements are provided with the same reference numerals. The exemplary embodiments of the present invention relate to devices and methods for configuration of a device. Exemplary embodiments of the present invention will be described with reference to a mobile computing device (“MCD”) that includes visual and audio components. However, those skilled in the art will understand that the present invention may also be implemented with any device that can receive data from another device and operate a component thereof in response to the received data. Thus, other exemplary embodiments may include stationary devices such as a desktop computer, a television, a programmable appliance, etc. Further embodiments may also include other mobile devices such as cell phones, personal digital assistants (“PDAs”), enterprise digital assistants (“EDAs”), radios, multimedia players, Bluetooth devices, etc.

The exemplary embodiments of the present invention may be implemented as a component (e.g., a hardware and/or software component) within an MCD (e.g., a PDA) that is used for tasks such as phone calls, email, note taking, calendar, contacts, task management, etc. These tasks may be performed directly on the MCD, which may synchronize itself (e.g., synchronizing the calendar, email, etc.) with another computing device via wireless or cabled arrangements. The MCD may also take direct user input.

As will be described in detail below, exemplary embodiments of the present invention may take data from the MCD's calendar and configure the MCD in accordance with the user's schedule. This configuration may include, but is not limited to, silencing a ringer or other audio device during a scheduled meeting, downloading meeting files and presentations needed for a particular appointment, attaching to a wireless network, automatically deactivating radios for an airplane flight, and putting the MCD to sleep at the end of the day. The exemplary embodiments of the present invention may be configurable to the extent the user desires the MCD to be managed. For example, the component may be selectively enabled and disabled.

An exemplary embodiment of the present invention will now be described with reference to a system in which an MCD receives data from a primary device. This arrangement may be advantageous in situations where a user operates the primary device more frequently than the MCD. However, those skilled in the art will understand that in other embodiments, the MCD may function as a stand-alone device without a need for additional hardware. In these other embodiments, the user may interact solely with the MCD.

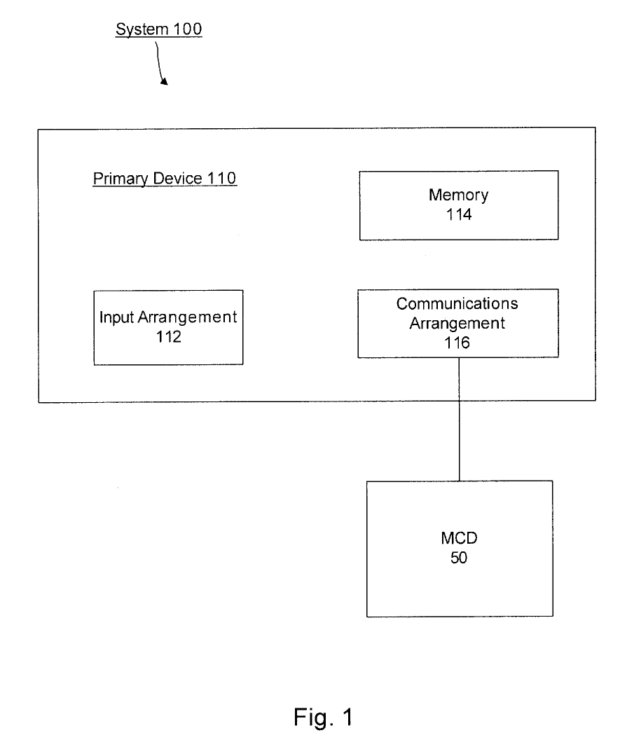

FIG. 1 shows an exemplary embodiment of a system 100 according to the present invention. The system 100 may include a primary device 110 and an MCD 50. The primary device 110 may be any device capable of communicating data to the MCD 50. In one embodiment, the primary device 110 may be a desktop computer or a server. In other embodiments, the primary device 110 may be another MCD that the user wishes to coordinate (e.g., synchronize) with the MCD 50. Thus, the primary device 110 may not necessarily perform functions similar to those of the MCD 50.

The MCD 50 may be any mobile computing device such as a laptop or a tablet computer. As shown in FIG. 1, the MCD 50 may be coupled to a communications arrangement 116 of the primary device 110. The communications arrangement 116 may be any wired or wireless arrangement that transmits data to or receives data from the MCD 50. For example, in one embodiment the communications arrangement 116 may be a wired arrangement comprising a hardware port (e.g., a serial, parallel, Universal Serial Bus or Firewire port). In another embodiment, the communications arrangement 116 may be a wireless arrangement communicating according to a wireless protocol (e.g., Bluetooth, IEEE 802.11a/b/g, a WAN protocol, an RF protocol, etc.).

As will be discussed in detail further below, the communications arrangement 116 may be used to transfer scheduling data from the primary device 110 to the MCD 50. The scheduling data may include an event during which a specific configuration of the MCD 50 is desired.

The scheduling data may be stored in a memory 114 of the primary device 110. The memory 114 may be any readable and/or writeable storage medium such as RAM, EPROM, Flash memory, etc. The memory 114 may also comprise other types of storage mediums including a hard drive, a compact disk, a magnetic tape, etc. The memory 114 may function as a temporary storage device on which the scheduling data is stored until the scheduling data can be transferred to the MCD 50. Alternatively, the memory 114 may serve as a primary storage for the scheduling data. For example, the memory 114 may store a master copy of the scheduling data against which other copies (e.g., a copy located on the MCD 50) are verified for consistency. In one embodiment, the memory 114 may include a calendar of events that is synced to a calendar of the MCD 50.

The primary device 110 may also include an input arrangement 112. The input arrangement 112 may be any arrangement by which the user inputs the scheduling data. The input arrangement 112 may, for example, comprise a keyboard, a keypad, a pointing device (e.g., a mouse or joystick), a touch screen, etc. Using the input arrangement 112, the user may select a time period corresponding to the event. This may be a one-time event or a recurring event (e.g., daily, weekly, monthly, etc.). The user may also input a written description of the event, an event type (e.g., internal meeting, client meeting, conference call, lunch, travel, etc.), a list of event participants, self-reminders and other information relating to the event. The user input may be transferred to the memory 114 (e.g., added to the calendar). The primary device 110 may also receive scheduling data from other devices via the communications arrangement 116, e.g., an email appointment. In this manner, scheduling data corresponding to any number of events may be inputted or received and stored.

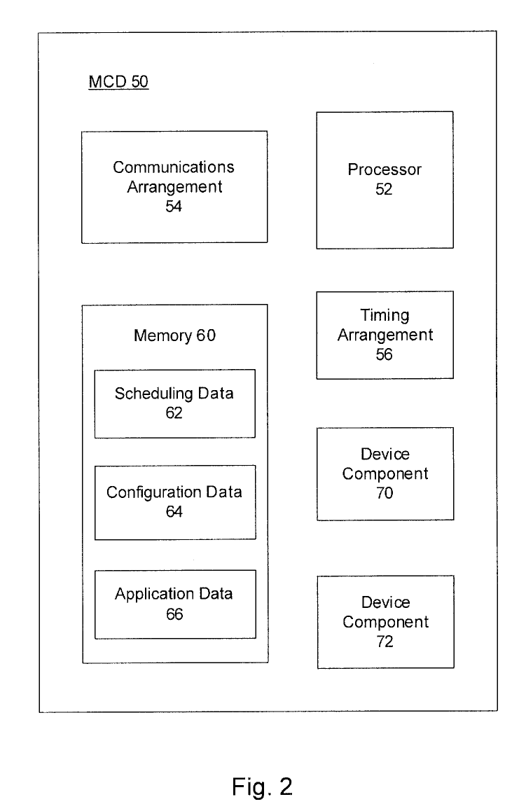

FIG. 2 shows a block diagram of an exemplary embodiment of the MCD 50 according to the present invention. The MCD 50 may include a processor 52, a communications arrangement 54, a memory 60, a timing arrangement 56, and one or more device components 70, 72. The processor 52 may be a microprocessor, an embedded controller, an application-specific integrated circuit, or any other combination of hardware and/or software capable of executing instructions and performing computations. The processor 52 may execute one or more applications such as a word processing application, a media presentation application, a personal planner application, etc.

The communications arrangement 54 may be any wired or wireless arrangement capable of communicating with the primary device 110 (e.g., via the communications arrangement 116). For example, if the primary device 110 includes a hardware port, the communications arrangement 54 may comprise one or more corresponding hardware ports to which a cable may be attached to connect to the hardware port of the primary device 110. If the primary device 110 includes a wireless arrangement, the communications arrangement 54 may comprise a wireless transceiver communication in accordance with the wireless protocol of the wireless arrangement. The communications arrangement 54 may be controlled by the processor 52 to receive the scheduling data from the primary device 110.

The timing arrangement 56 may be any combination of hardware and/or software that tracks elapsed time. For example, the timing arrangement 56 may be a real-time clock including one or more analog components (e.g., a quartz crystal or an RC circuit), one or more digital components (e.g., a digital counter or an integrated circuit), a counter software object such as a digital calendar executed by a processor, etc. The timing arrangement 56 may enable the MCD 50 to determine when scheduled events occur. The timing arrangement 56 may, for example, operate in conjunction with the calendar of the MCD 50 to determine the event(s) corresponding to the scheduling data. The timing arrangement 56 may operate continuously, updating itself with a current time per zone. Periodically, the timing arrangement 56 may adjust itself (e.g., by comparison to an external reference clock).

The memory 60 may be any readable and/or writeable storage medium such as RAM, EPROM, Flash memory, etc. or a combination thereof. The memory 60 may also comprise other types of storage mediums including a hard drive, a compact disk, a magnetic tape, etc. The memory 60 may store data required for device operation, including the scheduling data (e.g., a scheduling data 62), a configuration data 64 and an application data 66. As described above, the scheduling data 64 may include data corresponding to one or more events. The memory 60 may receive the scheduling data 62 from the communications arrangement 54 at predetermined times. For example, the MCD 50 may be configured to receive scheduling updates from the primary device 110 at regular intervals. The MCD 50 may also be manually updated (e.g. synced) at a request of the user.

The configuration data 64 may include information relating to an operation of one or more device components (e.g., the components 70, 72). For example, the component 70 may be an audio speaker and the component 72 may be a vibration unit. The components may be configured according to whether a particular event or type of event is occurring. For instance, if the event is a client meeting, both the components 70, 72 may be disabled or set to a silent mode (e.g., notification transducer). If the event is a conference call, only the component 72 may be enabled. If the event is lunch, either or both the components 70, 72 may be enabled depending on whether each component 70, 72 has been selected by the user.

The configuration data 64 may be stored as a user profile that may be accessed when the user identifies himself to the MCD 50 (e.g., by signing in with a username and/or password). The user may modify the configuration data 64 by changing one or more device settings (e.g., enabling or disabling a component when a particular event occurs). In one embodiment, the user may specify configurations for one or more modes of operation, such as a silent mode, a vibrate mode, a normal mode, etc. Thus, the user may create customized configurations that are associated with the user's profile. Alternatively, the configuration data 64 may be accessible to all users. For example, the configuration data 64 may comprise global configuration settings that are not adjustable by any user. In another embodiment, the global settings may be adjustable, but only by an authorized user such as a system administrator or device owner. The configuration data 64 may be modified locally (e.g., via an input arrangement of the MCD 50) or remotely (e.g., via the primary device 110).

In addition to describing the configuration of the components 70, 72, the configuration data 64 may also describe one or more actions to be performed by the MCD 50 in anticipation of the event(s). For example, the MCD 50 may be configured to perform actions such as downloading a file, uploading a file, establishing a connection to another device (e.g., a remote server), dialing a telephone number, etc. In one embodiment, the user may specify a particular file (e.g., a document or a multimedia presentation) to download at a predetermined time prior to the occurrence of the event (e.g., one hour). Files may also be managed in accordance with a pre-defined rule, such as archiving or performing a backup of new files at predetermined intervals. The MCD 50 may also be configured in accordance with a power setting such as putting the MCD 50 into a sleep mode when a large block of time without activity is determined (e.g., night time). Thus, the MCD 50 may be configured to perform any number of actions.

The application data 66 may include a file downloaded in accordance with the configuration data 64 (e.g., the document or presentation). The application data 66 may also include other data utilized by one or more applications. This may include both user data (e.g., documents) and program data (e.g., program files).

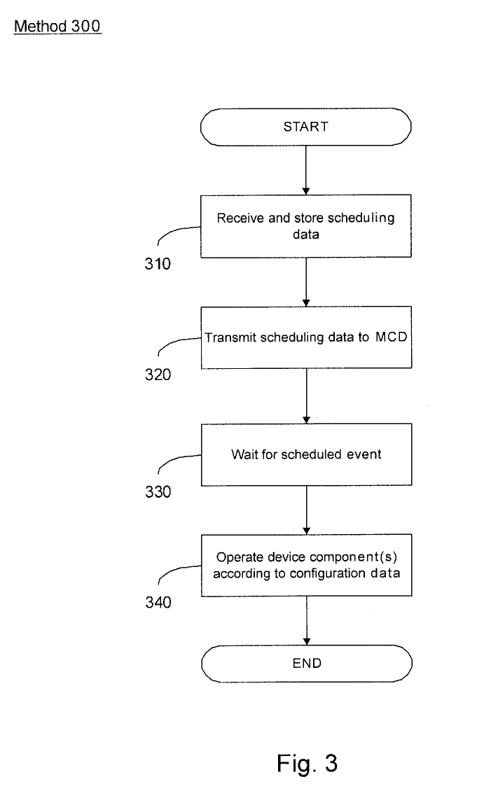

FIG. 3 shows an exemplary embodiment of a method 300 according to the present invention. The method 300 may be implemented on the system 100. In step 310, the primary device 110 receives the scheduling data from the user and stores the scheduling data in the memory 114. This may be a user input of new scheduling data corresponding to an event that has not yet been recorded. Alternatively, the scheduling data may be an update to an existing event record, such as when the user decides to change the event description or reschedule the event.

In step 320, the primary device 110 transfers the scheduling data to the MCD 50. The scheduling data is transmitted via the communications arrangement 116 and stored in the memory 60 (e.g., as the scheduling data 62). If the memory 114 is a temporary storage device, the scheduling data 62 may be erased from the memory 114 after being transmitted. The erasing may occur immediately after a successful transmission, or at predetermined times (e.g., when the memory 114 reaches a predetermined filled capacity).

In step 330, the MCD 50 waits for a scheduled event to occur. The scheduled event may occur at a known time previously specified by the user. The specified time may be determined by monitoring the timing arrangement 56. The determination of the scheduled event may be performed continuously (e.g., as a continuously running process executed by the processor 52). In another embodiment, the determination may occur in conjunction with an execution of a particular application. For example, the document may be associated with a word processing program. If the scheduled event is associated with a downloading of the document, the determination of the scheduled event may only occur if the word processing program is currently being executed.

In step 340, the MCD 50 operates one or more device components (e.g., the components 70, 72) according to the configuration data 64. As discussed above, the operation may comprise any number of actions. If the scheduled event is a client meeting, the component 70 (the audio speaker) may be disabled for a duration of the meeting and re-enabled when the meeting is over. Other operations may include putting the MCD 50 into the sleep mode (e.g., between the hours of 1 a.m. and 7 a.m.), downloading a document, sending email reminders to participants of a conference call, establishing a connection to a remote device, etc.

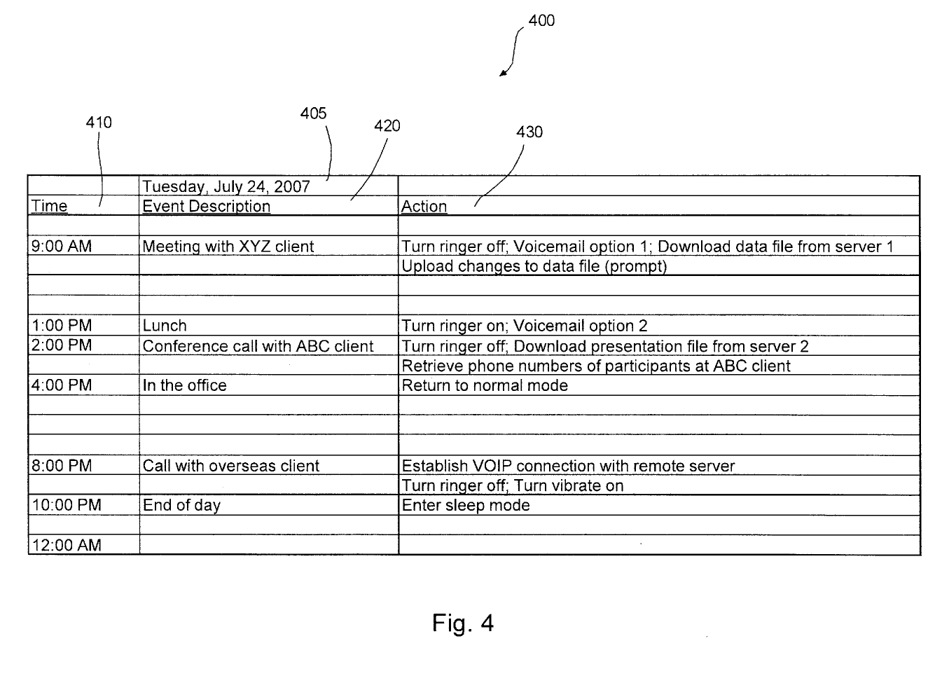

As a further illustration, FIG. 4 shows an exemplary embodiment of scheduling data. In particular, FIG. 4 is a table 400 describing exemplary scheduled events and corresponding actions that may be taken in response to the scheduled events. As discussed above, the scheduling data may be stored in the memory 60. Those skilled in the art will understand that any number of storage structures may be utilized to perform the storage. Input of the scheduling data may, as described above, be received from a primary device (e.g., the primary device 110) or received directly on the MCD 50. In addition, the illustration of the scheduling data and corresponding rules in table format is only exemplary. Any other type of storage and/or display format may be used.

The table 400 may include information relating to a time of a scheduled event. For example, the table 400 may include a date entry 405 and a time column 410 indicating when the scheduled event should occur. The table 400 may also include an event description column 420 and an action column 430. Actions listed in the action column 430 may correspond to user specified actions and/or the configuration data 64 as described above.

As shown in FIG. 4, the user may have a meeting with XYZ client at 9 AM. Accordingly, the MCD 50 may be configured to turn off a ringer (e.g., disabling the component 70). The MCD 50 may also be configured to select a first voicemail option (e.g., enabling a specific pre-recorded greeting). The user may also specify downloading of a data file required for the meeting from a server (e.g., a spreadsheet). The MCD 50 may be further configured to prompt the user to upload changes to the data file at an end of the meeting.

At 1 PM, the user may be scheduled to have lunch, in which case the ringer may be turned on (e.g., enabling the component 70). A second voicemail option may also be selected (e.g., selecting another pre-recorded greeting). At 2 PM, the user may have a conference call with client ABC, in which case the ringer may again be disabled and a presentation file (e.g., a slideshow) may be downloaded from another server. Phone numbers of participants in the conference call may also be retrieved. At 4 PM, the user may be scheduled to return to the office, in which case the MCD 50 may be configured to return to a normal mode.

At 8 PM, the user may be scheduled to have a call with an overseas client. The call may require the MCD 50 to establish a voice-over-IP (“VOIP”) connection to a remote server. Simultaneously, the ringer may be turned off and the vibrate mode may be enabled (e.g., enabling the component 72). At 10 PM, the user may no longer have any scheduled events for the day. Accordingly, the MCD 50 may be configured to enter the sleep mode, which may be entered into during a specified time (e.g., 10 PM everyday) or during a predetermined time period following a final scheduled event (e.g., one hour after the last event).

The exemplary embodiments of the present invention discussed above may enable automatic device configuration such that a user is able to specify in advance a desired configuration. Thus, the MCD 50 can be configured even if the user forgets. As an illustrative example, if the user is rushing to a meeting and forgets to configure the MCD 50 for silent operation (e.g., the silent mode or the vibrate mode), the MCD 50 may recognize the meeting as corresponding to the scheduled event and automatically configure itself to operate silently. As another example, if the user forgets to download a presentation ahead of time for the meeting, the MCD 50 may automatically download the presentation prior to a scheduled time of the meeting. Thus, the exemplary embodiments of the present invention may prevent the user from being ill-prepared or disruptive to the meeting.

In addition, the exemplary embodiments of the present invention may be implemented using either a single device (e.g., the MCD 50) or a plurality of coupled devices (e.g., the MCD 50 and the primary device 110). Thus, depending on the particular embodiment, the present invention may enable inputting of data into the MCD 50 in any number of ways.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A device, comprising:
a memory storing scheduling data and configuration data; and
at least one selectively configurable device component, wherein the device configures the at least one component as a function of the scheduling data and the configuration data.

2. The device of claim 1, wherein the scheduling data comprises a user calendar.

3. The device of claim 1, wherein the scheduling data includes a description of a scheduled event.

4. The device of claim 1, wherein the configuration data includes a predetermined device configuration associated with a specific event.

5. The device of claim 4, wherein the predetermined configuration is user-selectable.

6. The device of claim 1, wherein the configuration of the at least one component is one of enabling and disabling the component.

7. The device of claim 1, wherein the configuration of the at least one component includes a downloading of a file to the device.

8. The device of claim 1, wherein the configuration of the at least one component includes an establishing of a connection to a further device.

9. The device of claim 1, wherein the configuration includes placing the device into a sleep mode.

10. The device of claim 1, wherein the configuration occurs when the device determines that a scheduled event has occurred.

11. A method, comprising:
receiving scheduling data;
storing the scheduling data along with configuration data on a memory of a device; and
selectively configuring at least one component of the device, wherein the configuration is a function of the scheduling data and the configuration data.

12. The method of claim 11, wherein the scheduling data comprises a user calendar.

13. The method of claim 11, wherein the scheduling data includes a description of a scheduled event.

14. The method of claim 11, wherein the configuration data includes a predetermined device configuration associated with a specific event.

15. The method of claim 14, wherein the predetermined configuration is user-selectable.

16. The method of claim 11, wherein the configuration of the at least one component is one of enabling and disabling the component.

17. The method of claim 11, wherein the configuration of the at least one component includes a downloading of a file to the device.

18. The method of claim 11, wherein the configuration of the at least one component includes an establishing of a connection to a further device.

19. The method of claim 11, wherein the configuration includes placing the device into a sleep mode.

20. The method of claim 11, wherein the configuration occurs when the device determines that a scheduled event has occurred.

21. The method of claim 11, wherein the scheduling data is received from a master schedule stored on a separate device.

22. A device, comprising:
a storage means storing scheduling data and configuration data; and
at least one selectively configurable component means for performing an action, wherein the device configures the at least one component means as a function of the scheduling data and the configuration data.
